(19) United States
(12) Patent Application Publication
(10) Pub. No.: US 2026/0254499 A1
(43) Pub. Date: Aug. 27, 2026

(54) REPORTING CANDIDATE CELL SELECTION BASED ON PREDICTIVE MODEL

(71) Applicant: InterDigital Patent Holdings, Inc., Wilmington, DE (US)

(72) Inventors: Brian Martin, Farnham (GB); Filipe Conceicao, London (GB); Alain Mourad, Ascot (GB); Milind Kulkarni, Hawthorn Woods, IL (US); Ognen Ognenoski, London (GB)

(73) Assignee: InterDigital Patent Holdings, Inc., Wilmington, DE (US)

(21) Appl. No.: 19/159,367

(22) PCT Filed: Feb. 23, 2024
(86) PCT No.: PCT/US2024/017093

§ 371 Date: Aug. 25, 2025

Related U.S. Application Data
(60) Provisional application No. 63/448,096, filed on Feb. 24, 2023.

(51) Int. Cl. H04B 7/06; H04B 17/309

(52) U.S. Cl. CPC H04B 7/0626; H04B 17/309

(57) ABSTRACT

Systems, methods, and instrumentalities are disclosed herein for reporting candidate ceil selection based on a predictive model. A device may receive configuration information that indicates a set of layer one/layer two (L1/L2) triggered mobility (LTM) candidate cells, a predictive model, and a measurement threshoid. The device may predict, using the predictive model, a measurement value associated with an LTM candidate cell, wherein the LTM candidate cell is in the set of LTM candidate cells. The device may select the LTM candidate ceil based, at least in part, on the predicted measurement value satisfying the measurement threshold. The device may send, to a network entity, a message that indicates the selected LTM candidate cell. The device may perform channel state information (CSI) reporting on the selected LTM candidate cell.

### CROSS-REFERENCE TO RELATED APPLICATIONS

This application claims the benefit of U.S. Provisional Patent Application No. 63/448,096, filed Feb. 24, 2023, the contents of which are hereby incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein related to reporting candidate cell selection based on a predictive model.

A device (e.g., a wireless transmit/receive unit (WTRU) may be configured to receive configuration information that indicates a set of layer one/layer two (L1/L2) triggered mobility (LTM) candidate cells, a predictive model, and a measurement threshold. The device may predict, using the predictive model, a measurement value associated with an LTM candidate cell, wherein the LTM candidate cell is in the set of LTM candidate cells. The device may select the LTM candidate cell based, at least in part, on the predicted measurement value satisfying the measurement threshold. The device may send, to a network entity, a message that indicates the selected LTM candidate cell. The device may perform channel state information (CSI) reporting on the selected LTM candidate cell.

The predicted measurement value may be an output of the predictive model generated by use, as an input to the predictive model, of at least one of: a past measurement value associated with the LTM candidate cell or a current measurement value associated with the LTM candidate cell. The predicted measurement value may be associated with a reliability indicative of a probability that the predicted measurement value is accurate. The message may further indicate the predicted measurement value and the reliability.

The predicted measurement value associated with the LTM candidate cell may be a first predicted measurement value. The LTM candidate cell may be a first LTM candidate cell. The device may predict, using the predictive model, a second measurement value associated with a second LTM candidate cell. The second LTM candidate cell may be in the set of LTM candidate cells. The second predicted measurement value may be an output of the predictive model generated by use, as an input to the predictive model, of at least one of: a past measurement value associated with the second LTM candidate cell or a current measurement value associated with the second LTM candidate cell. The device may select the second LTM candidate cell from the set of LTM candidate cells based, at least in part, on the second predicted measurement value satisfying the measurement threshold. The message may further indicate the second LTM candidate cell.

The second predicted measurement value may satisfy the measurement threshold. The device may select the first LTM candidate cell based, at least in part, on the first predicted measurement value satisfying the measurement threshold by determining a first difference between the first predicted measurement value and the measurement threshold, and a second difference between the second predicted measurement value and the measurement threshold. On a condition that the first difference is greater than the second difference, the device may select the first LTM candidate cell.

The device may predict the measurement value associated with the LTM candidate cell by performing the prediction at a first time. The configuration information may further indicate a timescale indicative of a second time after the first time at which the measurement value is predicted. The device may predict the measurement value associated with the LTM candidate cell by predicting, at the first time, a value of the measurement at the second time, wherein the message further indicates the timescale.

The device may determine that a candidate cell selection condition has been satisfied. The device may determine, based on the candidate cell selection condition being satisfied, to evaluate one or more LTM candidate cells in the set of LTM candidate cells for selection.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example measurement model.

FIG. 3 illustrates an example of L1/L2-triggered mobility (LTM) using carrier aggregation (CA).

FIG. 4 illustrates an example of LTM.

FIG. 5 illustrates an example of network predictions.

FIG. 6 illustrates an example of LTM using longer-term predictions and shorter-term predictions.

FIG. 7 illustrates an example of LTM candidate dynamic fine tuning.

FIG. 8 illustrates example signaling associated with LTM candidate fine tuning.

FIG. 9 illustrates an example RRC set prediction event.

FIG. 10 illustrates example signaling associated with an RRC set prediction event.

FIG. 11 illustrates an example of determining a prediction validity timescale.

FIG. 12 illustrates example signaling associated with determining a prediction validity timescale.

FIG. 13 illustrates example signaling associated with determining a prediction validity timescale.

### DETAILED DESCRIPTION

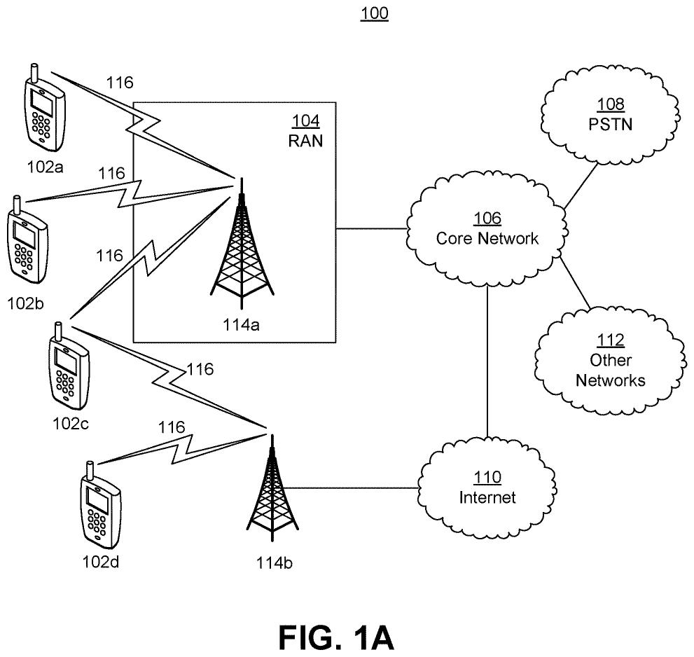

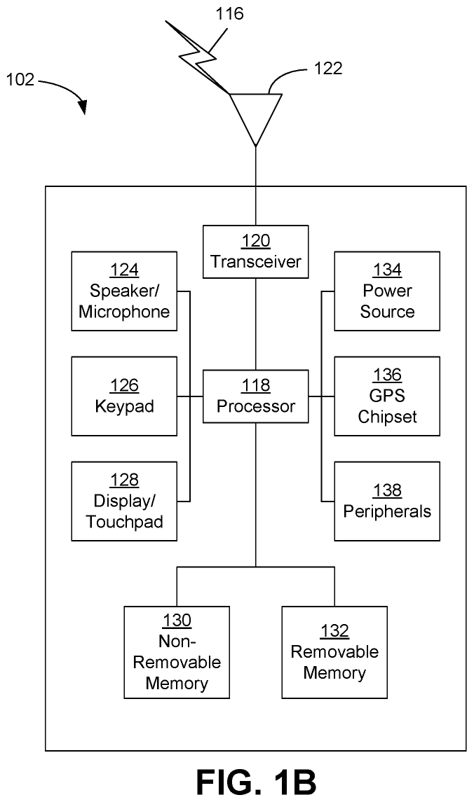

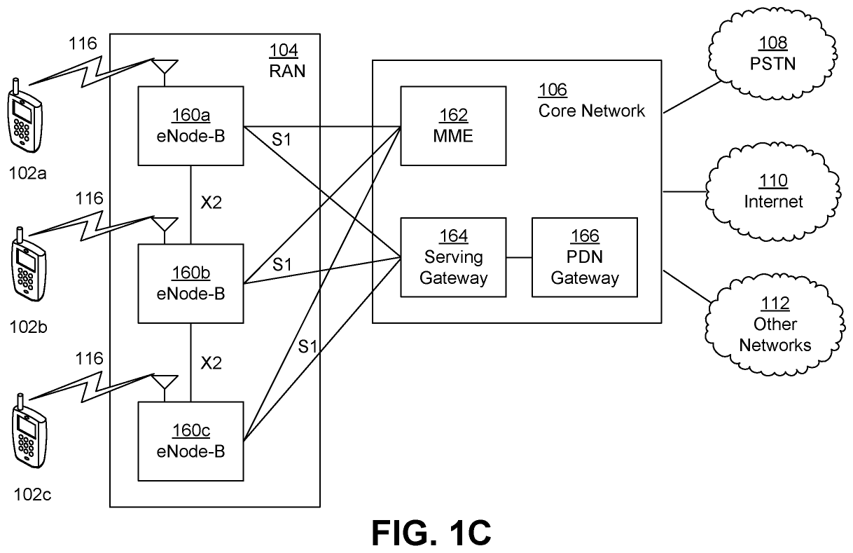

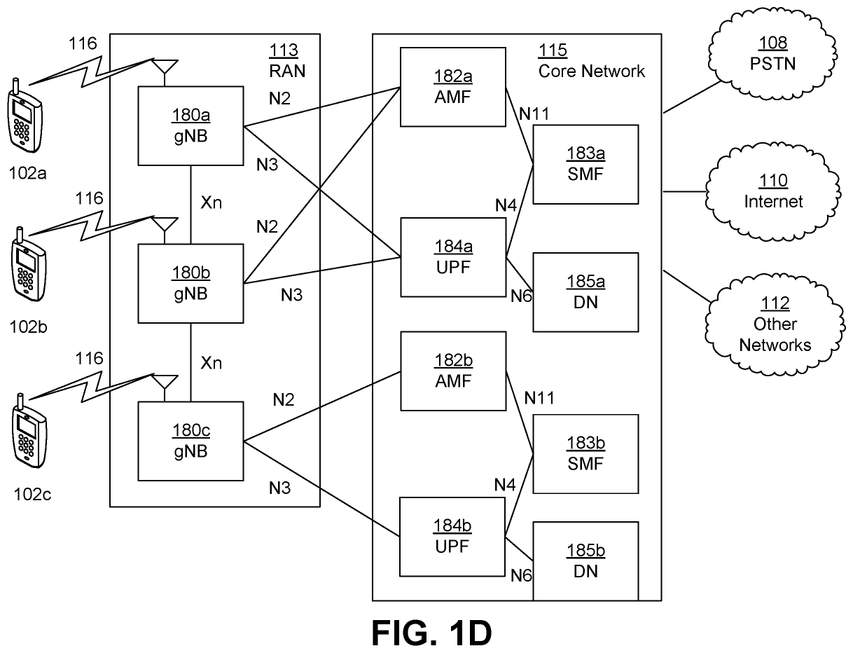

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 1020, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 1020 and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 1020, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like,

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 1020, 102d may implement a radio technology such as IEEE 802.11 to establish a wireless local area network (WLAN). In an embodiment, the base station 114b and the WTRUs 1020, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WIFI radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 1600 may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 1600 may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 1020, bearer activation/deactivation, selecting a particular serving gateway during an initial attach of the WTRUs 102a, 102b, 1020, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 1800 using subframe or transmission time intervals (TTIs) of various or scalable lengths (e.g., containing varying number of OFDM symbols and/or lasting varying lengths of absolute time). The gNBs 180a, 180b, 1800 may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 1800 without also accessing other RANs (e.g., such as eNode-Bs 160a, 160b, 160c). In the standalone configuration, WTRUs 102a, 102b, 102c may utilize one or more of gNBs 180a, 180b, 1800 as a mobility anchor point. In the standalone configuration, WTRUs 102a, 102b, 102c may communicate with gNBs 180a, 180b, 1800 using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 1800 and one or more eNode-Bs 160a, 160b, 160c substantially simultaneously. In the non-standalone configuration, eNode-Bs 160a, 160b, 160c may serve as a mobility anchor for WTRUs 102a, 102b, 1020 and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 1800 in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-horned PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, the term “predictive model” or “prediction model” may refer to an autoencoder model, an AI model, an AI/ML model, and/or the like. AI modelling or predictive modelling is the creation of a decision making process which follows 3 basic steps. The first step is the modelling step which uses one or more complex algorithms to make decisions based on interpreted data. The second step is model training which usually involves processing of large amounts of data using the AI model in iterative loops and checking the results to ensure accuracy. Based on the results the AI model may be modified and improved as it learns. The third step is inference which is the deployment of the AI model in a real situation where the model infers conclusions based on the data available. Common types of AI algorithms include, but are not limited to, Linear regression, decision trees, k-nearest neighbor, Naïve Bayes, support vector machine. Bagging combines multiple algorithms to produce a more accurate model. Deep neural network may be a structure of many layers of algorithms through which data is processed to make a final decision or prediction.

Feature(s) associated with an L1/L2 set are provided herein. A WTRU may report L1/L2-triggered mobility (LTM) cell candidates to the network (e.g., based on a configured predictive model and/or associated thresholds and measurements).

Feature(s) associated with a radio resource control (RRC) set are provided herein. For example, a mobility-like event may occur, for example, the WTRU may detect that a cell will soon be “visible” (e.g., based on a prediction being above a certain probability threshold).

The WTRU may determine a prediction validity timescale for a given prediction reliability based on measured conditions (e.g., WTRU speed, etc.) and may report to network (e.g., when a change above/below a threshold is detected).

Measurements may be performed (e.g., in NR), for example, on Uu. For example, a WTRU (e.g., in RRC_CONNECTED) may measure one or multiple beams for one or multiple cells. The measurement results (e.g., power values) may be averaged, for example, to derive cell quality. A WTRU may be configured to consider a subset of the detected beams. Filtering may be implemented at one or multiple (e.g., two different) levels, such as at the physical layer (e.g., to derive beam quality) and/or at the RRC level (e.g., to derive cell quality from one or more beams). Cell quality from beam measurements may be derived, for example, in the same or a similar way for the serving cell(s) and for the non-serving cell(s). Measurement reports may include the measurement results of the X best beams (e.g., based on a configuration of the WTRU by the gNB).

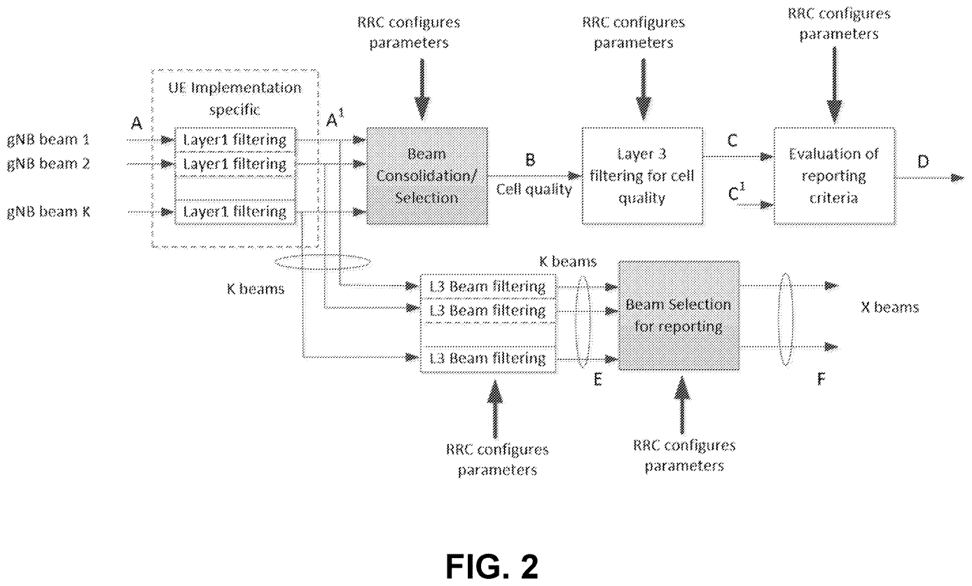

FIG. 2 illustrates an example of a measurement model. FIG. 2 shows an example of a high-level measurement model. K beams may correspond to the measurements on a synchronization signal block (SSB) or channel state information reference signal (CSI-RS) resources (e.g., configured for L3 mobility by the gNB and detected by WTRU at L1). As shown in FIG. 2, at A, measurements (e.g., beam specific samples) may be internal to the physical layer.

At layer 1 filtering, internal layer 1 filtering may be applied to the inputs measured at point A. Filtering may be implementation-dependent. Measurements may be executed in the physical layer.

At A1, measurements (e.g., beam specific measurements) may be reported by layer 1 to layer 3 (e.g., after layer 1 filtering).

At beam consolidation and/or selection, beam specific measurements may be consolidated to derive cell quality. The behavior of the beam consolidation and/or selection may be configured. Configuration information may be provided by RRC signaling.

At B, a measurement (e.g., cell quality) may be derived from beam-specific measurements reported to layer 3 (e.g., after beam consolidation and/or selection). A reporting period at B may be equal to one measurement period at A1.

At layer 3 filtering for cell quality, filtering may be performed on the measurements (e.g., provided at B, as shown in FIG. 2). The behavior of the layer 3 filters may be configured. Configuration information associated with the layer 3 filters may be provided by RRC signaling. A filtering reporting period (e.g., at C) may be equal to one measurement period at B.

At C, a measurement may be provided based on (e.g., after) processing in the layer 3 filter. The reporting rate may be the same (e.g., identical) or similar to the reporting rate at B. The measurement may be used as an input for one or more evaluations of reporting criteria.

At the evaluation of reporting criteria, an evaluation may be performed to determine whether measurement reporting is necessary (e.g., at D, as shown in FIG. 2). The evaluation may be based on one or more flows of measurements at C (e.g., to compare between different measurements). Input C and C1 show an example of multiple flows of measurements. The WTRU may evaluate the reporting criteria for a (e.g., each new) measurement result reported at C and/or C1. The reporting criteria may be configured. Configuration information may be provided by RRC signaling (e.g., WTRU measurements).

At D, measurement report information may be sent (e.g., in a message) on the radio interface.

At L3 beam filtering, filtering may be performed on the measurements (e.g., beam specific measurements) provided at A1. The behavior of beam filters may be configured. Configuration information associated with the beam filters may be provided by RRC signaling. A filtering reporting period at E may be equal to one measurement period at A1.

At E, a measurement (e.g., beam-specific measurement) may be generated (e.g., after processing in the beam filter). The reporting rate may be the same as (e.g., identical to) or similar to the reporting rate at A1. The measurement may be used as an input for selecting measurements (e.g., the X measurements) to be reported.

Beam selection for beam reporting may select X measurements from the measurements provided at point E. The behavior of beam selection may be configured. Configuration information may be provided by RRC signaling.

At F, beam measurement information may be included in a measurement report sent on the radio interface.

Layer 1 filtering may introduce a (e.g., configured) level of measurement averaging. How and when/if a WTRU performs measurements may be configured (e.g., implementation-specific). Layer 3 filtering for cell quality and related parameters used may be configured (e.g., to avoid introducing delay in the sample availability between B and C). Measurement(s) at C and/or C1 may be the input used in the event evaluation. L3 beam filtering and related parameters used may be configured (e.g., to avoid introducing delay in the sample availability between E and F).

Inter-cell L1/L2 triggered mobility (LTM) may be implemented. Inter-cell beam management may be used to manage the beams (e.g., to manage beams in carrier aggregation (CA). Cell change/add may (or may not) be supported. L1/L2 based inter-cell mobility may be implemented to reduce mobility latency. Configuration and maintenance may be provided for multiple candidate cells to allow fast application of configurations for candidate cells (e.g., RAN2, RAN3). Dynamic switching among candidate serving cells (e.g., including SpCell and SCell) may be provided for applicable scenarios based on L1/L2 signaling (e.g., RAN2, RAN1). L1 enhancements may be provided for inter-cell beam management (e.g., including L1 measurement and reporting, and beam indication (e.g., RAN1, RAN2). Timing Advance management may be provided (e.g., RAN1, RAN2). Centralized unit-distributed unit (CU-DU) interface signaling may be provided to support L1/L2 mobility (e.g., RAN3). L1/L2 based inter-cell mobility may be applicable to one or more of the following scenarios: standalone (e.g., CA and NR-DC case with serving cell change within one cell group (CG); Intra-DU case and intra-CU inter-DU case (e.g., applicable for standalone and CA); intra-frequency and inter-frequency scenarios; frequency range (FR) (e.g., FR1 and FR2); source and target cells (e.g., synchronized or non-synchronized); and/or inter-CU case.

L1/L2-based mobility and inter-cell beam management may be applicable to intra-DU and intra-frequency scenarios. The serving cell may remain unchanged (e.g., there may be no possibility to change the serving cell using L1/L2 based mobility). In FR2 deployments, CA may be used to exploit the available bandwidth (e.g., to aggregate multiple CCs in one band). These CCs may be transmitted with the same analog beam pair (e.g., gNB beam and WTRU beam). The WTRU may be configured with TCI states (e.g., a large number of TCI states, for example, 64) for reception of PDCCH and PDSCH. A (e.g., each) TCI state may include an RS or SSB that the WTRU may refer to for setting its beam. The SSB may be associated with a non-serving PCI. MAC signaling (e.g., “TCI state indication for WTRU-specific PDCCH MAC CE”) may activate the TCI state for a control resource set (CORESET) and/or PDCCH. Reception of PDCCH from a non-serving cell may be supported by a MAC CE indicating a TCI state associated to non-serving PCI. MAC signaling (e.g., “TCI States Activation/Deactivation for WTRU-specific PDSCH”) may activate a subset of (e.g., up to 8) TCI states for PDSCH reception. DCI may indicate which of the 8 TCI states is activated. A “unified TCI state” with a different updating mechanism (e.g., DCI-based) may be supported (e.g., but may be without multi-TRP). A unified TCI state with multi-TRP may be supported.

The WTRU may send (e.g., may first send) a measurement report using RRC signaling (e.g., during a conventional L3 handover or conditional handover). In response to the RRC signaling, the network may provide a further measurement configuration and potentially a conditional handover configuration. With a conventional handover, the network may provide a configuration for a target cell after the WTRU reports (e.g., using RRC signaling) that the cell meets a configured radio quality criteria. With conditional handover, to reduce the handover failure rate due to the delay in sending a measurement report and receiving an RRC reconfiguration, the network may provide (e.g., in advance) a target cell configuration and a measurement criteria that determines if/when the WTRU should trigger the CHO configuration. L3 methods may suffer from some amount of delay due to the sending of measurement reports and receiving of target configurations (e.g., particularly in case of the conventional (non-conditional) handover).

LTM may improve handover latency. LTM may allow a fast application of configurations for candidate cells, including dynamically switching between SCells and switching of the PCell (e.g., switch the roles between SCell and PCell) without performing RRC signaling. The inter-CU case may not be included, as inter-CU signaling may involve (e.g., require) relocation of the PDCP anchor. An RRC-based approach may be used to support inter-CU handover.

In L3 handover mechanisms, any currently active SCell(s) may be released before the WTRU moves (e.g., completes the handover) to a target cell in the coverage area of a new site. The SCell(s) may be (e.g., may only be) added back after successful handover, which leads to throughput degradation during handover. L1/L2 may enable CA operation to be enabled instantaneously upon serving cell change.

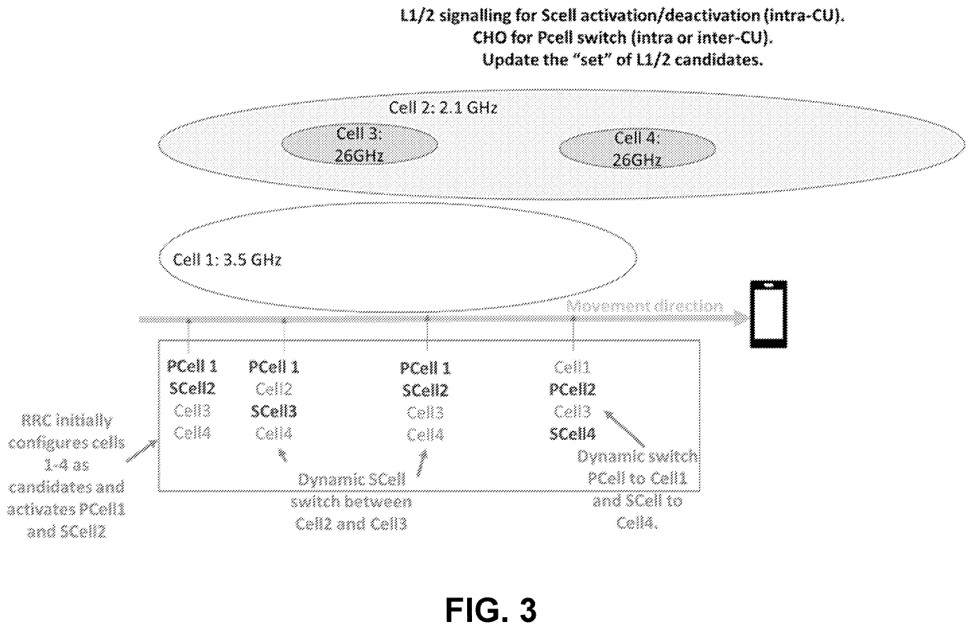

FIG. 3 illustrates an example LTM using CA. The candidate cell group may be configured by RRC. A dynamic switch of PCell and SCell may be achieved using L1/L2 signaling.

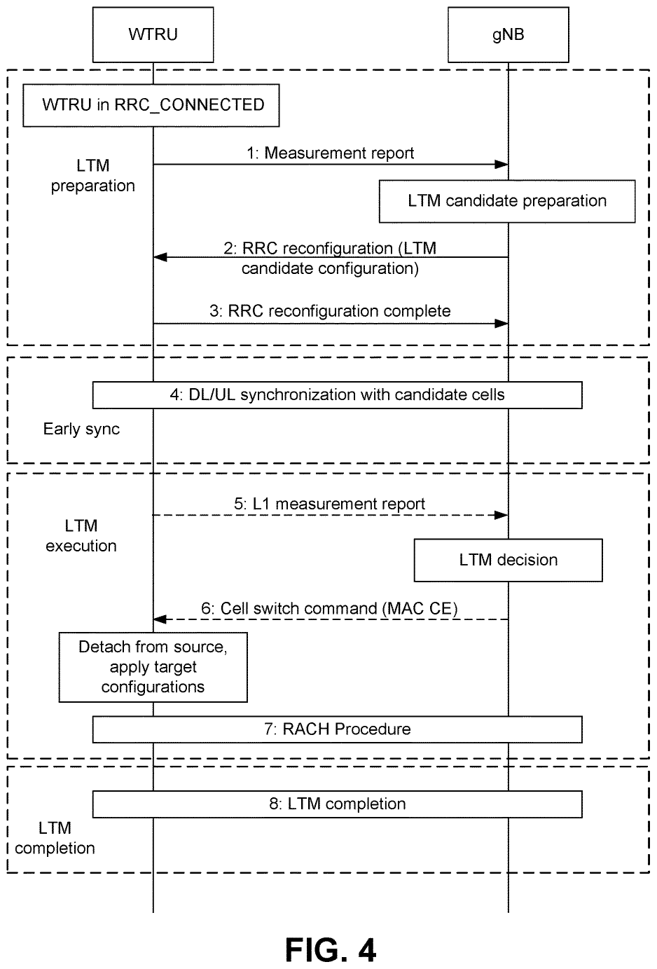

FIG. 4 illustrates an example LTM baseline procedure. LTM may involve one or more of the following actions. As shown in FIG. 4, at 1, the WTRU may send a MeasurementReport message to the gNB. The gNB may decide to use LTM. The gNB may initiate LTM candidate preparation. At 2, the gNB may transmit an RRCReconfiguration message to the WTRU including the configuration of one or multiple LTM candidate target cells. At 3, the WTRU may store the configuration of LTM candidate target cell(s) and may transmit an RRCReconfigurationComplete message to the gNB. At 4, the WTRU may perform DL synchronization and TA acquisition with candidate target cell(s) before receiving the LTM cell switch command. DL synchronization for candidate cell(s) may be performed before cell switch command (e.g., based on SSB).

TA acquisition of candidate cell(s) may be performed before LTM cell switch command (e.g., based on PDCCH ordered RACH), where the PDCCH order may be (e.g., may only be) triggered by source cell.

As shown in FIG. 4, at 5, the WTRU may perform L1 measurements on the configured LTM candidate target cell(s), and may transmit lower-layer measurement reports to the gNB. At 6, the gNB may decide to execute LTM cell switch to a target cell. The WTRU may transmit a MAC CE triggering LTM cell switch by including the candidate configuration index of the target cell. The WTRU may switch to the configuration of the LTM candidate target cell. At 7, the WTRU may perform random access procedure towards the target cell (e.g., if TA is not available). At 8, the WTRU may indicate successful completion of the LTM cell switch towards the target cell.

Artificial intelligence (AI) may refer to the behavior exhibited by machines. AI may refer to a machine's ability to perceive, synthesize, and infer information. Such behavior may mimic cognitive functions to sense, reason, adapt, and/or act.

Machine learning (ML) may refer to the type of algorithms that solve a problem based on learning through experience (e.g., data) without explicitly being programmed to do so (e.g., by a configured set of rules). ML may be considered a subset of AI.

Different machine learning paradigms may be envisioned based on the nature of data or feedback available to the learning algorithm. For example, a supervised learning approach may involve learning a function that maps an input to an output based on a labeled training example (e.g., wherein each training example may include an input and the corresponding output). For example, an unsupervised learning approaches may involve detecting patterns in the data with no pre-existing labels. For example, a reinforcement learning approach may involve performing a sequence of actions in an environment to increase (e.g., maximize) the cumulative reward. ML algorithms may be applied using a combination or interpolation of the above-mentioned learning approaches. For example, a semi-supervised learning approach may use a combination of a small amount of labeled data with a large amount of unlabeled data during training. In this regard, semi-supervised learning falls between unsupervised learning (e.g., with no labeled training data) and supervised learning (e.g., with only labeled training data).

Deep learning may refer to the class of ML algorithms that employ artificial neural networks loosely inspired from biological systems (e.g., deep neural networks (DNNs). For example, DNNs may include a class of machine learning models inspired by the human brain. In DNNs, an input may be linearly transformed. In DNNs, an input may be passed through non-linear activation function(s) multiple times. DNNs may include multiple layers. For example, a layer (e.g., each layer) may include a linear transformation and/or non-linear activation function(s). DNNs may be trained using training data via a back-propagation algorithm. DNNs may exhibit state-of-the-art performance in a variety of domains (e.g., speech, vision, natural language etc.) and in various machine learning settings (e.g., supervised, un-supervised, semi-supervised, and/or the like).

Auto-encoders (AE) are a class of deep neural networks (DNNs) that arise in the context of unsupervised machine learning setting (e.g., wherein the high-dimensional data is non-linearly transformed to a lower dimensional latent vector using a DNN-based encoder and the lower dimensional latent vector is used to reproduce the high-dimensional data using a non-linear decoder). The encoder may be represented as E(x; Wₑ), where x is the high-dimensional data and Wₑ represents the parameters of the encoder. The decoder may be represented as D(z; W_{d}), where z is the low-dimensional latent representation and W_{d} represents the parameters of the decoder. Further, using training data {x₁, . . . , x_{N}}, the auto-encoder can be trained by solving the following optimization problem.

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem can be approximately solved using a backpropagation algorithm. The trained encoder E(x;Wₑ^{tr}) may be used to compress the high-dimensional data and the trained decoder

$$D ( z ; {W}_{d}^{tr} )$$

may be used to decompress the latent representation.

The terms artificial intelligence (AI), machine learning (ML), deep learning (DL), and DNNs may be used interchangeably. Some feature(s) described herein are exemplified based on learning in wireless communication systems. The methods are not limited to such scenarios, systems and services and may be applicable to any type of transmissions, communication systems and/or services, etc.

Recurrent Neural Networks (RNNs) may be algorithms that may be effective in modeling sequential data. RNNs contain internal memory that enables the model to remember previous inputs as well as current inputs to help sequence modelling. The output for a (e.g., any) step within the neural network may not only depend on the current input, but also on the output generated at previous steps. They can exemplify how a neural network may track evolving conditions for a given task (e.g., in terms of tracking the impact of the changes in one or more of the following: channel/radio, change in latency, bitrate, jitter), for example, for the purpose of determination on how to apply QoS treatment on a per packet basis for a given flow, and/or the like.

Example types of processing are provided herein.

Feature(s) associated with rule-based processing are provided herein.

The term “rule-based” processing may refer to specified WTRU behavior and/or requirements that are explicitly defined in the form of procedural text, signaling syntax, and/or the like. Rule-based processing may refer to any processing based on legacy algorithms that are essentially non-AI based (e.g., a logical channel prioritization (LCP) procedure). An entity that performs AI processing may be referred as a rule-based component.

Feature(s) associated with AI processing are provided herein.

The term “AI processing” may refer to specified WTRU behavior and/or processing or parts thereof that are learned based on training using data. AI processing may involve one or more of classical machine learning techniques and/or deep learning techniques. AI processing may apply one or more AI model architectures to perform one or more of: classification, prediction, pattern recognition, dimensionality reduction, estimation, interpolation, clustering, regression, compression, recommendation, approximation of an arbitrary function, etc. AI processing may utilize supervised, unsupervised, reinforcement learning, or a variant thereof. For example, an AI model applying AI processing may be trained by various techniques such offline training, online training, online refinement, or a combination thereof. For example, such training may be performed locally on the WTRU, partially on the WTRU, or downloaded from the network. An entity that performs AI processing may be referred as AI component or an AI filter.

Feature(s) associated with contextual AI component(s) are provided herein.

A WTRU may be configured with one or more (e.g., a plurality of) AI models. An AI model (e.g., each AI model) may be associated with a context. For example, a context may refer to a set of conditions under (and/or during) which the performance of the AI model is expected to be satisfactory. The performance of an AI component may be related to inference accuracy for the given task of the AI model used by the AI component.

A contextual AI model may be defined as an AI model that is associated with a specific context. The inference accuracy of a contextual model depends on the context under which the model is executed. The size, training time, inference latency, complexity, and/or power consumption associated with a contextual AI model may be lower (e.g., much lower) than that of an AI model that is expected to perform under all contexts.

The L1/L2 triggered mobility (LTM) may involve a gNB configuring target candidate cells based on a WTRU detecting and reporting RRC measurements (e.g., beforehand). One or more candidates may be added too late. In LTM, L1 measurement reports may be used to identify a suitable target cell for handover more quickly due to faster measurement evaluation and reporting. Relying on L3 reporting to detect and add candidate cell(s) may not remove the associated delay, and the handover failure rate may still be too high (e.g., due to radio link failure (RLF) on the source cell before a handover can be executed).

There may be RRC signaling overhead. A measurement report may be needed before configuring a candidate cell. A network entity (e.g., a gNB) may “blindly” configure target candidate cells (e.g., may configure candidates without receiving a WTRU measurement report). Blind configuration may result in too many (or the incorrect) candidate cells being configured (e.g., which may be wasteful of network resources, for example, that could be used to prepare a target cell). Blind configuration may imply overhead (e.g., significant overhead) in the early synchronization phase. For example, to manage a subset of the configured target cells, the WTRU may synchronize and perform L1 (e.g., CSI-RS) reporting.

Feature(s) associated with streamlining the configuration overhead and network resource usage (e.g., capacity), while supporting faster LTM based mobility, are provided herein. Feature(s) associated with using AI/ML functionality are provided herein. A WTRU and network may utilize predicted path, measurement, and traffic information to manage (e.g., intelligently manage) the configured candidate cells and measurements.

As used herein, “perform LTM” or “perform LTM procedures” may refer to performing actions associated with LTM (e.g., such as those described with respect to FIG. 4). For example, performing LTM may involve early synchronization in downlink and/or uplink to one or more candidate cells, performing L1 measurements and reporting on one or more of the candidate cells, switching (e.g., performing handover) between candidate cells (e.g., “perform LTM” may mean that the WTRU moves/switches between multiple candidate cells), and/or the like.

Feature(s) associated with candidate cell sets are provided herein.

The one or more candidate cell sets may be groups of more than one RRC configuration (e.g., corresponding to a handover configuration for one or more candidate SpCells and, optionally, SCells). The one or more candidate cell sets may be modelled or received as one or more complete RRC reconfiguration messages, one or more cell group configurations, or one or more cell configurations. A cell candidate configuration (e.g., each of the candidate cell configurations) may include a candidate configuration identifier. A candidate cell group (e.g., each of the candidate cell groups) may include a candidate cell group identifier. If the grouping is performed at the RRC level, the switching between different sets of candidate cells may include updating the serving cell indexes or candidate configuration indexes. The indexes may be used in L1 and MAC signaling to refer to specific cells or configuration. For example, a MAC CE triggering the reconfiguration may include a candidate configuration index informing the WTRU of a cell to which to perform the reconfiguration.

The one or more candidate cell groups may be configured as a single list or a group of candidate cell configurations at the RRC level. The grouping may occur at the early synchronization or LTM execution phase (e.g., rather than the configuration phase). The candidate cell set may be considered as a group (e.g., a single group) in terms of an RRC configuration list or group. The cells selected for performing early synchronization, L1 measurements, and LTM execution may depend on a further grouping into multiple subsets of the overall candidate cell list. The grouping itself may not be modelled at the RRC level using candidate configuration identifiers. For example, the grouping may be executed as part of the early synchronization or the LTM execution procedure.

As used herein, references to an “LTM candidate configuration” may apply to any type of preconfigured cell information. For example, a WTRU may be configured with one or more conditional reconfigurations such as conditional handover (CHO), conditional PSCell addition (CPA), and/or conditional PSCell change (CPC), which may be valid before and/or after a cell change, or valid in certain cells.

Feature(s) associated with L1 measurement are provided herein.

As used herein, an “L1 measurement” may refer to a measurement, performed by a WTRU, of RSRP, RSRP, RSSI, etc., of a cell, beam, set of cells, or set of beams. Such L1 measurement may be similar to L3 measurements reported in radio resource management (RRM), with differences in the filtering, reference signals measured, reporting mechanisms, etc.

L1 measurement may apply to RRM reporting.

As used herein, “measurements” refers to L1 measurements for LTM. Feature(s) described herein may similarly apply to RRM/L3 measurements, as well as other measurements (e.g., measurements of speed, location, height, traffic, etc.).

Feature(s) associated with network and/or WTRU prediction capabilities (e.g., based on AI/ML techniques) are provided herein.

Conditions that a WTRU experiences may come from real measurements the WTRU performs (e.g., over time). For example, a WTRU in mobility may read the current serving cell's RSRP, and report the RSRP to the network. If the WTRU is moving to an area approaching the serving cell's edge, the WTRU may record that RSRP values are decreasing. These values may be communicated to the network via measurement reports. The network may use the measurement reports to make a decision.

The network may have a pre-trained AI/ML model that is able to produce predictions of air-interface measurements (e.g., RSRP, RSRQ, SINR, etc.) of serving and/or neighbor cells (e.g., any cell). The predictions may be used to anticipate (e.g., predict) the radio conditions that the WTRU will experience (e.g., instead of waiting for the WTRU to report the conditions).

The network may predict measurements (e.g., RSRP) in a time series manner (e.g., to produce meaningful predictions). For example, from the moment the network predictions are triggered, the WTRU may produce several prediction outputs over a future time span (e.g., with a certain granularity or time step).

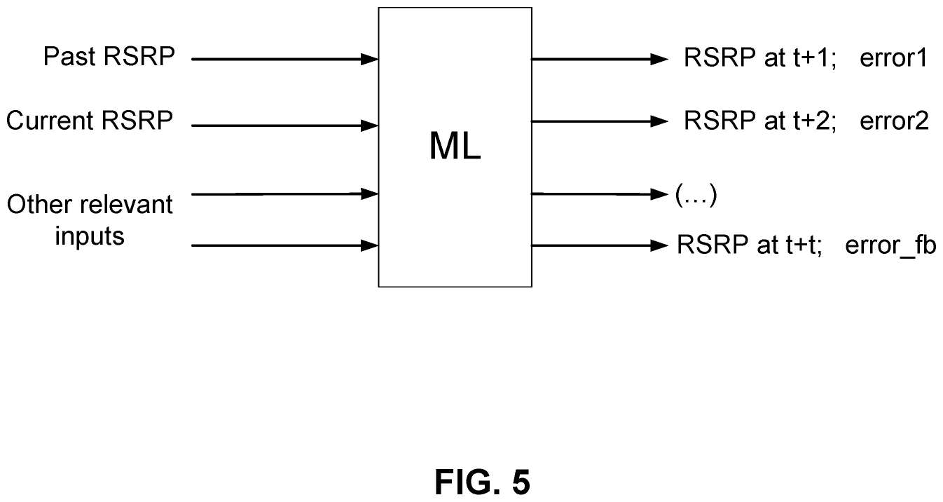

FIG. 5 illustrates an example time series prediction for RSRP. For example, at time t, the network may predict one RSRP prediction point per time step from time t+1 until t+t_{fb}.

The predictions may be performed for a (e.g., one) point in time (e.g., only one point in time). The predictions may extend over several time steps. Prediction(s) with time series output(s) may be beneficial (e.g., more beneficial than single value predictions), for example, because it may be difficult to match the prediction with an event (e.g., a network-configured event) with a (e.g., single) prediction point. One or more events may trigger the network predictions.

A WTRU may be configured to predict future measurements based on current and/or historical measurements. For example, the WTRU may be configured with a trained AI/ML model that is able to produce predictions for radio interface radio signal levels. The AI/ML model at the WTRU may be implementation-based. The AI/ML model the WTRU may obtain the AI/ML model from the network. The AI/ML model may be configured to take, as an input, current and/or historical RSRP measurements. The AI/ML model may be configured to take additional inputs such as, for example, WTRU location information, WTRU mobility, etc. The AI/ML model may be configured to produce single-value predictions (e.g., RSRP at a future time instant t). The AI/ML model may be configured to predict a series of RSRP values corresponding to future time instances (e.g., t+1, t+2, and so on up to t+t_{fb}).

An AI model may be trained ofline, or online. An AI model may be exchanged (e.g., determined or transferred based on a signaling exchange between the WTRU and the network) during pre-configuration.

Fast mobility gains (latency, reduced handover failure (HOF) may be maintained or improved (e.g., compared to some other LTM techniques), for example, because cells may be prepared in advance (e.g., even before measurements).

Handover, early synchronization, CSI-RS measurement, or any part of performing LTM may be triggered in advance of measurements based on predictions. This may further improve mobility latency and mobility failure (e.g., handover failure, radio link failure) rates.

Network capacity gain may come from reduced signaling for preparing candidates (e.g., because a limited subset can be configured based on prediction); and/or the network preparing a smaller subset of targets (e.g., which may allow the network resource usage to be reduced, for example, by preparing resources on fewer potential target cells).

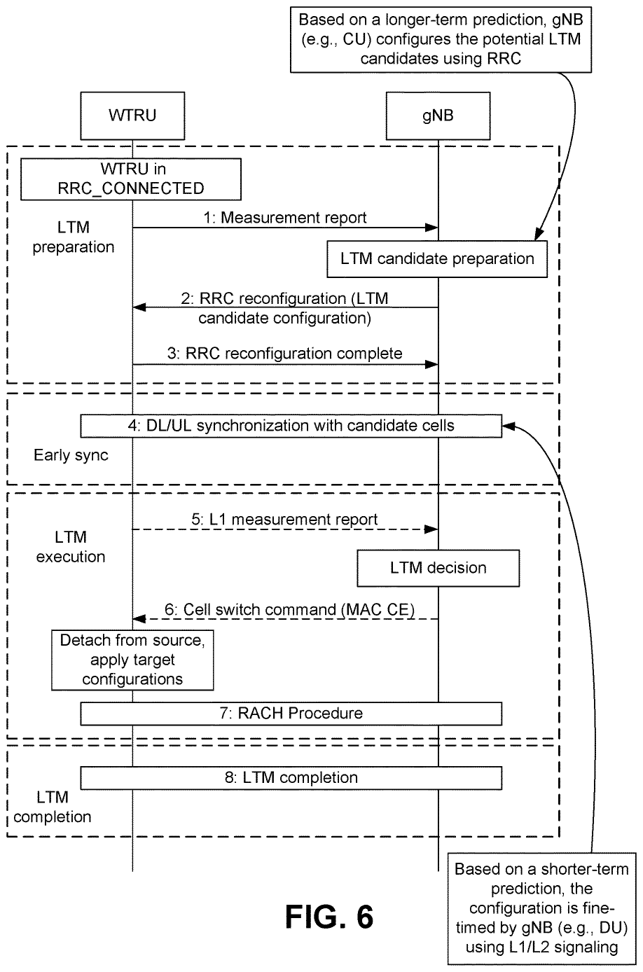

FIG. 6 illustrates an example of LTM using longer-term predictions and shorter-term predictions.

One or more layers (e.g., two layers) of AI prediction may be introduced to LTM, for example, a longer-term prediction and a shorter-term prediction. The longer-term prediction may be used for managing the RRC configuration of LTM candidate cells. The shorter-term prediction may be used to dynamically fine-tune and adjust the configuration (e.g., using L1/L2 techniques). The longer-term prediction and/or the shorter-term prediction may be estimated by the WTRU or the network.

Feature(s) associated with configuration based on a longer-term prediction are provided herein.

Based on a longer-term prediction, a network entity (e.g., a gNB or a CU in case of CU/DU split architecture) may configure potential LTM candidates using RRC signaling. The WTRU may receive the LTM candidate configurations using an RRC reconfiguration message (e.g., during the “LTM preparation” phase shown in FIG. 6). The WTRU may store the LTM candidate configurations. The WTRU may (e.g., later) apply the LTM candidate configurations upon receiving (e.g., using L1/L2 signaling, for example, a MAC CE), an indication to perform a cell switch (e.g., during the “LTM execution” phase shown in FIG. 6).

The configuration of potential LTM candidates may include candidate sets. For example, a first candidate set may be suitable for a first predicted path (e.g., a first action taken by a WTRU) and a second candidate set may be suitable for a second predicted path (e.g., a second action taken by the WTRU).

One or more of the candidate set information may be broadcast in system information. The WTRU may enable the pre-configuration of the broadcast configurations upon receiving an indication in dedicated signaling (e.g., RRC reconfiguration). The indication may indicate the broadcast one or more configurations (e.g., using an index or identifier).

The configuration based on the longer-term prediction may include one or more (e.g., all or a subset) of the potential cells in a specific area (e.g., all cells belonging to the CU with which the WTRU is currently connected, or cells within a particular geographical area). These cells may not have been detected or measured by the WTRU (e.g., yet), but may have been configured in advance. The longer-term prediction may be based on a static configuration. For example, the network may configure a set (e.g., the same set) of LTM candidate cells based on the current cell in which the WTRU is currently connected. If the longer-term prediction is based on network specific information, the WTRU may not be (e.g., may not need to be) aware of the conditions or criteria used to determine the LTM candidate set received from the network.

The WTRU may (e.g., after the initial configuration of LTM candidate configurations) receive an update to the configuration to modify, add, remove, or replace any part of the LTM candidate configurations.

The WTRU may receive an indication to enable or disable one or more of the LTM configurations. For example, if it is predicted that the WTRU mobility would be better handled using L3 (e.g., RRC measurement report, RRC reconfiguration, conditional reconfiguration), then LTM may be disabled. If it is predicted that LTM would better suit the WTRU mobility, then LTM may be enabled (e.g., a previously configured and disabled LTM configuration may be re-enabled).

The longer-term prediction may be based on a prediction model that is internal to, and determined by, the network (e.g., a gNB). This prediction may be based on the paths that the network prediction model determines are the WTRU's most likely paths.

The WTRU may provide an enhanced measurement report (e.g., RRC Measurement Report) to provide a WTRU estimate of the predicted path. The enhanced measurement report may include current WTRU measurements (e.g., cell quality metrics such as RSRP of current and/or neighbor cells). The enhanced measurement report may include predicted measurements or other predicted information. The WTRU may transmit a measurement report periodically (e.g., every N milliseconds). The WTRU may trigger a measurement report based on predetermined (e.g., configured) criteria (e.g., based on real measurements, predicted events, or a combination thereof). The WTRU may (e.g., prior to configuration) report which of one or more predefined models is supported by the WTRU. The WTRU may receive an indication (e.g., from the network) specifying which of the one or more supported models are to be used in a prediction (e.g., any prediction).

The longer-term prediction may consider the WTRU reported information and/or the network-estimated or predicted information.

The path prediction may involve one or more of the following: one or more cells or beams (e.g., SSBs) through which WTRU is likely to travel and/or be able to detect; a predicted/estimated timescale associated with the cells; mobility history information; estimated WTRU cell measurements (e.g., cell RSRP); estimated WTRU beam measurements (e.g., beam RSRP); optimal SpCell and/or SCell configurations and activation state; positioning information (e.g., such as GPS co-ordinates); speed/velocity information; expected active services (e.g., 5QI information); expected throughput/data rates; and/or expected data amounts.

Feature(s) associated with fine-tuning the configuration based on a shorter-term prediction are provided herein.

Based on a shorter-term prediction, the gNB (e.g., DU in case of CU/DU split architecture) may control or modify the WTRU behavior using a subset of the LTM candidate set configured based on the longer-term prediction.

The WTRU may transmit prediction information using L1/L2 signaling (e.g., in a MAC CE, or a CSI-RS report in UCI). The prediction information may be transmitted with, or separately from, measurement information. For example, a MAC CE (or CSI-RS report) may include predicted and/or real RSRP beam measurements for a subset of the LTM candidate cells.

The WTRU may transmit a report containing prediction information using L1/L2 signaling (e.g., in a MAC CE or in a CSI-RS report or other UCI) in the “early synchronization” phase of the LTM procedure (e.g., as shown in FIG. 6). The prediction information provided in the report may be used by the network to determine actions to request for the WTRU to perform. The determination may be made based on (e.g., based only on) the WTRU-reported information. The determination may be made based on the WTRU-reported information and a model implemented in the network. The WTRU may receive an indication to initiate downlink and/or uplink synchronization of one or more of the LTM candidate cells. The WTRU may receive an indication to initiate L1 reporting (e.g., CSI-RS reporting) on one or more beams on one or more of the LTM candidate cells.

The WTRU may transmit a report including prediction information using L1/L2 signaling (e.g., in a MAC CE or in a CSI-RS report or other UCI), for example, in the “LTM execution” phase of the LTM illustrated in FIG. 6). The prediction information provided in the report may be used by the network to determine actions to request for the WTRU to perform. The determination may be made based on (e.g., based only on) the WTRU-reported information. The determination may be made based on the WTRU-reported information and a model implemented in the network. The WTRU may receive an indication for the WTRU to execute LTM to one or more of the LTM candidate cells (e.g., SpCell and/or Scell).

The information transmitted in the uplink report may Include predicted L1 measurements. For example, the information may include a prediction for one or more of the following: cri-RI-PMI-CQI; cri-RI-i1; cri-RI-i1-CQI; cri-RI-CQI; cri-RSRP; ssb-Index-RSRP; cri-RI-LI-PMI-CQI; one or more beam or cell identifiers that are predicted to become detectable; one or more LTM candidate cell or cell set identifiers; an index to one of multiple predefined measurement values; an (e.g., explicit) indication of a cell quality measurement value; an indication of whether one or more of the reported values is predicted or a measurement; an indication of the model used for prediction; and/or an indication of a timescale used for prediction.

Feature(s) associated with an L1/L2 set are provided herein. The WTRU may report LTM cell candidates to the network based on a configured predictive model. The WTRU may report thresholds and measurements associated with the LTM cell candidates and/or predictive model.

The WTRU may receive (e.g., via RRC) configuration information that indicates (e.g., includes) a set of LTM candidate cells and a configuration for predictive measurements and/or reporting. For example, the configuration for predictive measurements and/or reporting may include one or more of the following: a measurement threshold (e.g., thresholds for reporting, for example, radio condition, route change, service change) and an associated predictive timescale (if applicable); and/or a predictive model (e.g., a predictive model/model ID) and associated model inputs.

The WTRU may select a subset of candidate cells (e.g., an LTM candidate cell in the set of LTM candidate cells) based on measurements, the predictive model, and the configured thresholds/timescale. For example, the WTRU may predict a measurement value associated with an LTM candidate cell and select the LTM candidate cell based, at least in part, on the predicted measurement value satisfying the measurement threshold. The WTRU may use one or more of the following during selection: current radio measurements meeting a threshold; predicted radio measurements for a timescale meeting a threshold; and/or a prediction of cells that will (e.g., soon) be detectable (e.g., based on fingerprint, route prediction, current/past measurements, and/or the like). For example, the WTRU may perform the prediction at a first time (e.g., a present time). The timescale may indicate a second time (e.g., after the first time) at which the measurement value is predicted. The WTRU may predict the measurement value associated with the LTM candidate cell by predicting (e.g., at the first time) a value of the measurement at the second time.

The WTRU may send (e.g., transmit) an indication to the network of the selected LTM candidate cell (or subset of candidate cells). The indication may indicate the associated measurement(s) (e.g., the predicted measurement value) and/or cause information (e.g., whether the selection was predicted or non-predicted). The indication may be transmitted via MAC CE.

The indication may indicate a timescale for the prediction and/or an associated reliability of the prediction. The timescale may indicate a time by which the cell will become available.

The WTRU may receive (e.g., via a MAC CE) an activation message for a subset of LTM candidate cells, and/or an indication of the CSI-RS reporting configuration.

The WTRU may perform CSI reporting on the selected LTM candidate cell. For example, the WTRU may initiate CSI-RS reporting, downlink synchronization, uplink synchronization (e.g., RACH), and/or the like.

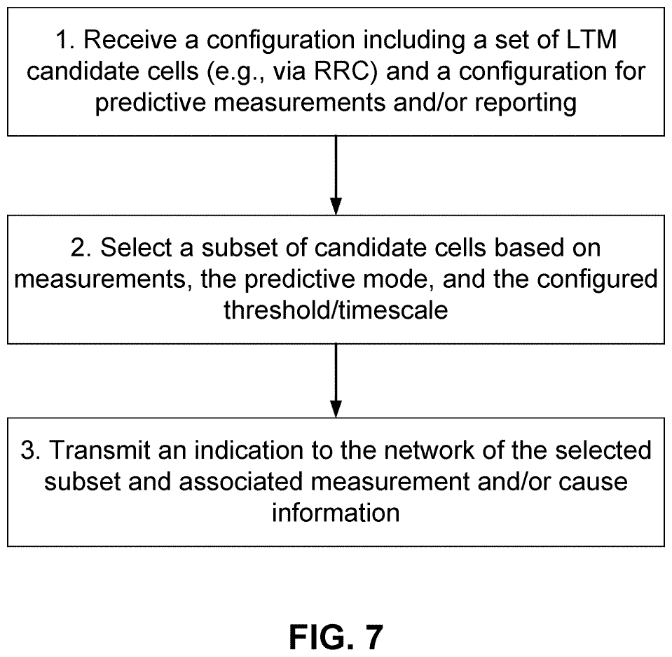

FIG. 7 illustrates an example of LTM candidate dynamic fine tuning. As shown, a WTRU may receive configuration information including a set of LTM candidate cells (e.g., via RRC). The WTRU may receive configuration information for predictive measurements and/or reporting. The WTRU may select a subset of candidate cells based on measurements, the predictive model, and/or the configured threshold(s)/timescale. For example, the predicted measurement value may be an output of the predictive model generated by use, as an input to the predictive model, of at least one of: a past measurement value associated with the LTM candidate cell or a current measurement value associated with the LTM candidate cell. The WTRU may transmit an indication to the network of the selected subset and associated measurements and/or cause information.

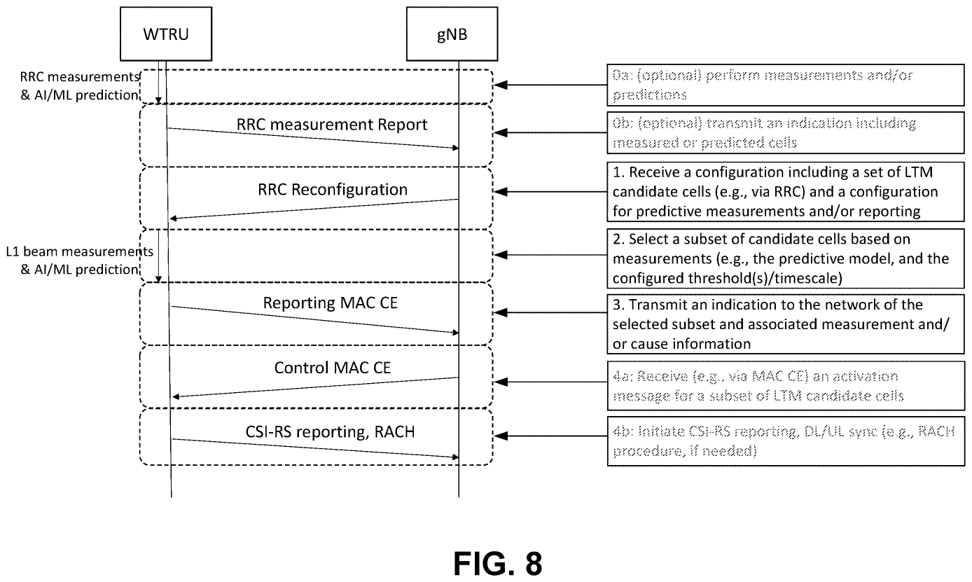

FIG. 8 illustrates example signaling associated with LTM candidate dynamic fine tuning. As illustrated in FIG. 8, at 0a, the WTRU may have been (e.g., previously) configured to perform measurements and/or predictions of a set of LTM candidates or potential LTM candidate cells. At 0b, the WTRU may transmit a measurement report, indicating measurements and/or predictions of potential LTM candidate cells. At 1, the WTRU may receive configuration information that indicates (e.g., includes) a set of LTM candidate cells (e.g., via RRC reconfiguration). The WTRU may receive configuration information for predictive measurements and/or reporting. At 2, the WTRU may select a subset of candidate cells (e.g., of the configured candidate cells) based on measurements, the predictive model, and the configured threshold(s)/timescale.

For example, the WTRU may determine (e.g., predict using the predictive model) a first predicted measurement value associated with a first LTM candidate cell in the set of LTM candidate cells. The WTRU may predict (e.g., using the predictive model) a second measurement value associated with a second LTM candidate cell in of the set of LTM candidate cells. The first predicted measurement value may be an output of the predictive model generated by use, as an input to the predictive model, of at least one of: a past measurement value associated with the first LTM candidate cell or a current measurement value associated with the first LTM candidate cell. The second predicted measurement value may be an output of the predictive model generated by use, as an input to the predictive model, of at least one of: a past measurement value associated with the second LTM candidate cell or a current measurement value associated with the second LTM candidate cell. The WTRU may select the first LTM candidate cell from the set of LTM candidate cells based, at least in part, on the first predicted measurement value satisfying the measurement threshold. The WTRU may select the second LTM candidate cell from the set of LTM candidate cells based, at least in part, on the second predicted measurement value satisfying the measurement threshold.

In another example, the WTRU may determine a first difference between the first predicted measurement value and the measurement threshold, and a second difference between the second predicted measurement value and the measurement threshold. On a condition that the first difference is greater than the second difference, the WTRU may select the first LTM candidate cell. Similarly, on a condition that the second difference is greater than the first difference, the WTRU may select the second LTM candidate cell.

At 3, the WTRU may transmit an indication (e.g., using MAC CE) of the selected subset (e.g., the first and/or second selected LTM candidate cells) and associated measurement and/or cause information to the network. At 4a, the network may (e.g., after the WTRU transmits the indication) transmit (and the WTRU may receive) an activation message for a subset of LTM candidate cells. At 4b, if the WTRU receives an activation message at 4a, the WTRU may initiate CSI reporting and/or early synchronization in downlink and/or uplink (e.g., RACH) on the indicated subset of LTM candidate cells.

Feature(s) associated with configuration of LTM candidate cells are provided herein.

The LTM candidate set may have been configured based on the reporting at 0a and 0b. The actions described at 0a/0b may not be performed (e.g., the WTRU may receive the configuration for LTM candidate cells based on network-determined criteria, for example, criteria internal to the network). For example, the network may use a predictive model, or the network may select one or more (e.g., certain) cells within a geographical area.

Any criteria may be used by the network (e.g., including WTRU reporting prior to the actions taken at 1) to determine LTM candidate cells to include in the set of LTM candidate cells provided at 1.

Feature(s) associated with configuration for predictive measurements and/or reporting are provided herein.

The configuration for predictive measurements and/or reporting may have been received by the WTRU prior to the actions taken at 0a/0b. The configuration for predictive measurements and/or reporting may be received in the same message (e.g., RRC configuration) as the LTM candidate set. The configuration for predictive measurements and/or reporting may be received in a separate message (e.g., RRC measurement control) than the message used to send the LTM candidate set.

The configuration of predictive measurements and/or reporting may include one or more of the following: an indication of a condition (e.g., a triggering condition to send a report); radio thresholds for reporting (e.g., a measured or predicted cell or beam signal quality is above an absolute or relative threshold, for example, a relative threshold that is relative to a serving cell/beam or reference cell/beam); an indication of one or more measurement quantities (e.g., as described herein); a threshold number of cells or beams for which an event is satisfied before triggering an event or report (e.g., a number of cells that are added or changed in the selected subset); identification of one or more beams or cells for which to apply the triggering conditions; a predictive timescale (e.g., for prediction-related event trigger, for example, how far in advance to perform the prediction); a predictive model/model ID; predictive model inputs (e.g., current measurements, past measurements, throughput); and/or a target probability or accuracy for prediction.

Example candidate cell selection conditions (e.g., conditions for selecting a subset of LTM candidate cells) are provided herein. The WTRU may determine that a candidate cell selection condition has been satisfied. The WTRU may determine, based on the candidate cell selection condition being satisfied, to evaluate one or more LTM candidate cells in the set of LTM candidate cells for selection.

For example, the WTRU may use one of more of the following conditions for selecting one or more cells (e.g., a subset of the LTM candidate cells) or for triggering an event or report: a condition to select/deselect or trigger an event/report if one or more route changes have been detected (e.g., the WTRU changes direction, detects that the WTRU has entered a moving vehicle, detects that the WTRU has entered a building, etc.); a condition to select/deselect or trigger an event/report if a service changes (e.g., the WTRU predicts or detects that a new service type is starting, or if an expected throughput or data amount requirement will change); a condition to select/deselect or trigger an event/report if one or more cells or beams that are not currently detected will be detected (e.g., are predicted to be detected) or if one or more cells or beams are detected (e.g., are measured); a condition to select/deselect or trigger an event/report if one or more cells or beams will have (e.g., are predicted to have) or have (e.g., are measured to have) a measurement quantity above a configured threshold; a condition to select/deselect or trigger an event/report if one or more conditions are met within a certain time period; and/or a condition based on availability of computation resources to perform selection.

Feature(s) associated with content and format of the indication of a subset of LTM candidate cells are provided herein.

The indication of a subset of LTM candidate cells may be transmitted in an uplink MAC CE. The indication of a subset of LTM candidate cells may be transmitted in a CSI-RS report or other L1 UCI.

The indication of a subset of LTM candidate cells may use a bitmap of identities, where a bit (e.g., each bit) refers to a configuration (e.g., LTM configuration) index. Setting one of the bits to “1” may indicate that the cell or beam referred to by the index meets a certain condition (e.g., is selected as part of the subset or has satisfied a triggering condition).

The indication of a subset of LTM candidate cells may include an (e.g., explicit) identifier that indicates the cell or beam fulfilling a criteria.

The indication may include a measurement, for example, a predicted or actual RSRP value (e.g., or any of the measurement quantities described herein).

The indication may include an identification of a particular event or criteria that has been met. For example, multiple conditions may be configured and the indication identified those conditions. The identification of the event may (e.g., implicitly) inform the network of the subset of cells (e.g., a particular ID may be associated with a specific cell/beam or subset of cells/beams and a condition that must be met to select that cell/bear or subset of cells/beams).

The indication may include a timescale (e.g., a number of milliseconds or subframes after a reference time when a predicted event is expected to place).

The indication may include a reliability probability (e.g., the WTRU may indicate with X % probability that a predicted event will occur in the expected indicated timescale).

Feature(s) associated with an RRC set are provided herein. A mobility-like event may occur. For example, the WTRU may detect that a cell will soon be “visible” based on a prediction being above a certain probability threshold.

The WTRU may receive (e.g., via RRC) configuration information that indicates (e.g., includes) a first (e.g., configured) set of LTM candidate cells and a configuration for evaluating and reporting a comparison of the configured first set of candidate cells and a WTRU-determined/predicted one or more candidate cell(s) not included in the configured first set of candidate cells. For example, the configuration information may indicate/include one or more of the following: one or more measurement criteria to apply to the WTRU-determined/predicted one or more candidate cell(s) (e.g., a threshold, add/remove/replace criteria, etc.); one or more second sets of candidate cells (e.g., corresponding to different routes or different service types); a predictive model; and/or prediction model parameters (e.g., a timescale, for example, how far in the future to predict, and/or what to take into consideration, for example, path, single cells, etc.).

The WTRU may determine a set of candidate cells based on the predictive model and the measurement criterion. For example, the WTRU may evaluate (e.g., based on a configured criteria) whether one or more of the conditions are met. For example, the WTRU may predict that the WTRU will be able to measure a candidate cell that is not in the configured first set of candidate cells (e.g., that measurements of the candidate cell will be above a threshold) within a certain time. The determined candidate cell may be considered valid and may be added to an updated first set of candidate cells. For example, the WTRU may use the predictive model to predict, at a first time, a measurement value associated with a candidate cell at a second time after the first time. If the predicted measurement value satisfies the measurement criterion, the WTRU may include the candidate cell in the determined set of candidate cells. The candidate cells in the determined set of candidate cells may be associated with a direction of travel of the WTRU (e.g., cells that will be measurable at a future time due to the WTRU's movement).

The WTRU may predict that the WTRU will not be able to measure a candidate cell in the configured first set of candidate cells (e.g., that measurements of the candidate cell will be below a threshold) within a certain time. The candidate cell may be considered invalid and may be removed from an updated first set of candidate cells.

The WTRU may compare the configured set of candidate cells to the determined set of candidate cells. The WTRU may determine, based on the comparison, at least one of: a first candidate cell that is unique to the configured set of candidate cells or a second candidate cell that is unique to the determined set of candidate cells. For example, a threshold number of cells in a WTRU-determined/predicted set of candidate cells may be different from the candidate cells in the configured first set of candidate cells (e.g., X WTRU-determined/predicted valid candidate cells may not be in the configured first set of candidate cells, or X cells in the configured first set of candidate cells may not be in the WTRU-determined/predicted set of valid candidate cells).

The WTRU may send/transmit (e.g., to the network) an indication of the event that has been detected, and associated supplementary information. For example, the indication may include an indication of cells (e.g., WTRU-determined/predicted or configured) in which the triggering event occurred.

The supplementary information may include predicted measurement values (e.g., RSRP), a reason/cause (e.g., path change, speed change, etc.), and/or the like.

The WTRU may receive (e.g., via RRC reconfiguration) an updated set of LTM candidate cells (e.g., a third set to replace the first set). For example, the WTRU may receive an indication from the network entity (e.g., in response to the indication of the cells determined by the WTRU). The indication from the network may instruct the WTRU to update the configured set of candidate cells. Based on the indication from the network, the WTRU may add the second candidate cell to the configured set of candidate cells to generate an updated configured set of candidate cells.

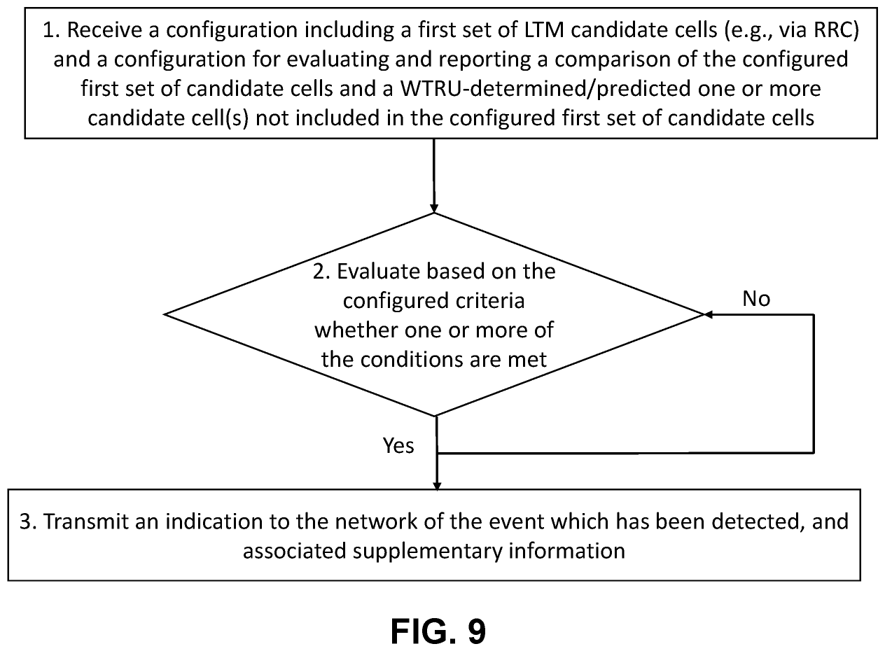

FIG. 9 illustrates an example RRC set prediction event.

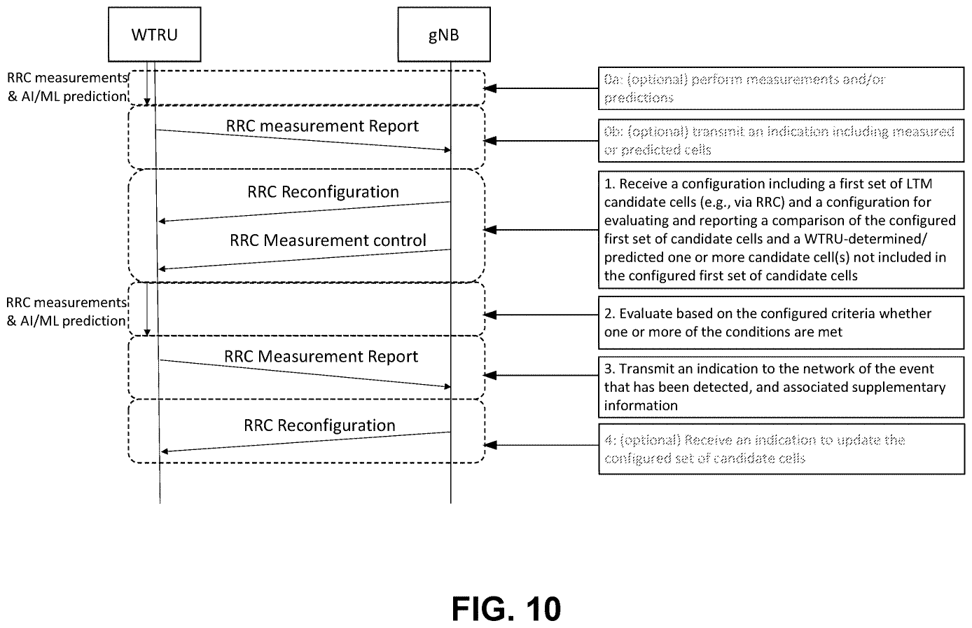

FIG. 10 illustrates example signaling associated with an RRC set prediction event.

As illustrated in FIG. 10, at 0a, the WTRU may be (e.g., may have been previously) configured to perform measurements and/or predictions of a set of LTM candidate cells or potential LTM candidate cells. At 0b, the WTRU may transmit a measurement report. The measurement report may indicate measurements and/or predictions of potential LTM candidate cells. At 1, the WTRU may receive a configuration including a first set of LTM candidate cells (e.g., via RRC) and a configuration for evaluating and reporting a comparison of the configured first set of candidate cells and a WTRU-determined/predicted one or more candidate cell(s) (e.g., that are not included in the configured first set of candidate cells).

For example, the WTRU may determine, based on the comparison, at least one of: the first candidate cell that is unique to the configured set of candidate cells or the second candidate cell that is unique to the determined set of candidate cells. The WTRU may determine, based on the comparison, the first candidate cell that is unique to the configured set of candidate cells, and remove the first candidate cell from the configured set of candidate cells. The WTRU may determine, based on the comparison, the second candidate cell that is unique to the determined set of candidate cells, and add the second candidate cell to the configured set of candidate cells.

At 2, the WTRU may evaluate (e.g., based on the configured criteria) whether one or more of the conditions are met. At 3, if one or more of the conditions are met, the WTRU may transmit an indication to the network of the event that has been detected, and associated supplementary information. For example, the WTRU may send an indication to the network that indicates at least one of: the determined set of candidate cells, the first candidate cell that is unique to the configured set of candidate cells, or the second candidate cell that is unique to the determined set of candidate cells.

The WTRU may determine (e.g., based on the comparison of the configured and determined sets of candidate cells) whether to update the configured set of candidate cells. For example, at 4, the network may (e.g., after the WTRU transmits the indication) transmit (and the WTRU may receive) an indication to update the configured set of candidate cells (e.g., to replace the first set of candidate cells with some or all of the reported WTRU-determined/predicted set).

Feature(s) associated with configuration of LTM candidate cells are provided herein.

The LTM candidate set may have been configured based on the reporting at 0a/0b. The actions described at 0a/0b may not be performed (e.g., the WTRU may receive the configuration for LTM candidate cells based on network-determined criteria (e.g., internal to the network, for example, the network may use a predictive model, or the network may select certain cells withing a geographical area).

One or more (e.g., any) criteria may be used by the network (e.g., including WTRU reporting prior to the actions at 1) to determine which candidate cells to include in the set of LTM candidate cells provided in step 1.

Feature(s) associated with configuration information for evaluating and reporting are provided herein.

The configuration information for evaluating and/or reporting the comparison of the configured LTM candidate set and the predicted set may have been received by the WTRU prior to the actions taken at 0a/0b.

The configuration information for evaluating and/or reporting the comparison of the configured LTM candidate set and the predicted set may be received in the same message (e.g., RRC configuration) as the LTM candidate set.

The configuration information for evaluating and/or reporting the comparison of the configured LTM candidate set and the predicted set may be received in a separate message (e.g., RRC measurement control) than the message used to send the LTM candidate set.

The configuration information for evaluating and/or reporting the comparison of the configured LTM candidate set and the predicted set may include one or more of the following: an indication of a condition (e.g., a triggering condition to send a report); radio thresholds for evaluation (e.g., a measured or predicted cell or beam signal quality is above an absolute or relative threshold, for example a relative threshold that is relative to a serving cell/beam or reference cell/beam); an indication of one or more measurement quantities (e.g., as described herein); a threshold number of cells for which an event is satisfied before triggering an event or report (e.g., a number of predicted cells and/or a number of configured cells meeting a criteria); identification of one or more cells in the LTM candidate set, or cells not in the LTM candidate set, for which to apply the triggering conditions; an indication of the number of cells to consider (e.g., N best cells in the configured set, or N best cells outside of the configured set); an indication of a reporting priority (e.g., if more than the maximum number of cells meet a condition, then one or more cells may be prioritized to be included in a report); a predictive timescale (e.g., for prediction-related event trigger, for example, how far in advance to perform the prediction); a predictive model/model identifier (ID); predictive model inputs (e.g., current measurements, past measurements, throughput); and/or a target probability or accuracy of the prediction.

Example conditions for triggering an event are provided herein.

The WTRU may determine (e.g., based on the configuration information for evaluation and reporting) whether the configured set and the determined/predicted set are different. For example, if the predicted set includes cells that are not configured, or vice-versa (e.g., the configured set includes cells that are not in the predicted set), the WTRU may trigger a report to the network.

The report may be triggered if (e.g., only if) a threshold number of cells are different between the configured and predicted set. For example, if the threshold number of cells is set (e.g., configured) to two (2) cells, and if one (1) cell outside of the configured set is determined to be in the predicted set, then no report may be triggered. As another example, if the threshold number of cells is set (e.g., configured) to two (2) cells, and if two (2) cells outside of the configured set are determined to be in the predicted set, then a report may be triggered.

The WTRU may determine whether to include a predicted cell in the predicted set (e.g., based on the one or more conditions in the received configuration). A cell may be considered to be included in the predicted set if the expected measurement is above a configured radio quality threshold (e.g., a predicted RSRP value). A cell may be considered to be included in the predicted set if the expected measurement is above a configured radio quality threshold within a certain time duration (e.g., if the cell RSRP is expected to be above X dBm within Y seconds).

A cell in the configured set may be considered for removal from a predicted set if the expected measurement is below a radio quality threshold (e.g., a predicted RSRP value). A cell may be considered for removal from the predicted set if the expected measurement is below a configured radio quality threshold within a certain time duration (e.g., if the cell RSRP is expected to be below X dBm within Y seconds).

Cells in the configured set may be (e.g., directly) compared to cells outside of the configured set to determine a predicted set. For example, a cell in the configured (and predicted) set may be compared to a cell outside of the configured (and predicted) set. The cell in the configured (and predicted) set may be replaced in the predicted set if the cell outside of the configured set is expected to have a better radio quality measurement (e.g., more than a configured relative threshold) than the cell in the configured set. The comparative radio quality measurement may be within a configured time period (e.g., if the cell outside of the configured set has RSRP that is expected to be better than the RSRP of the cell in the configured set during Y seconds, then the cell in the configured set may be replaced in the predicted set).

The WTRU may use a positioning estimate to determine which cells to include in the predicted set. For example, if the WTRU determines that the WTRU will be in the proximity of a cell at some point in the future, the WTRU may consider the cell to be in the predicted set. Similarly, if the WTRU determines that the WTRU will not be in the proximity of a cell in the configured set, the WTRU may determine that the cell should not be in the predicted set.

The WTRU may trigger a report to the network to indicate addition and/or removal and/or replacement of one or more cells in the configured set (e.g., if the configured conditions are met).

Feature(s) associated with content and format of the indication to update the configured candidate cell set are provided herein.

The WTRU may use an RRC measurement report to indicate a difference between the configured set and in the predicted set (e.g., a difference between elements included in the configured set and elements included in the predicted set). The WTRU may use a WTRU assistance information message to indicate a difference in the configured set and in the predicted set. Any RRC, MAC, or L1 message or control information may be used to convey this information.

The WTRU may provide a complete list of cells in the predicted set, for example, a list of PCIs, carriers, or cell identities. The WTRU may indicate (e.g., only indicate) the cells that are different between the predicted set and the configured set (e.g., cells to add, cells to remove, cells to replace).

The WTRU may indicate cells in the predicted set and/or cells in the configured set, and may provide predicted (e.g., estimated) and/or measured cell quality values (e.g., RSRP). The WTRU may indicate an associated timescale (e.g., an expected time that the event will occur).

The WTRU may indicate cells in the predicted set. The WTRU may indicate positioning information associated with the prediction. For example, the WTRU may provide an identification of a predicted cell with an estimated location of the WTRU when the WTRU expects that this cell will become a likely candidate. The indication may include an associated timescale (e.g., expected time that the WTRU expects that this cell will likely become a candidate).

A WTRU may determine the prediction validity timescale for a given prediction reliability (e.g., based on measured conditions, for example, WTRU speed, etc.). The WTRU may report (e.g., to the network) if a change above/below a threshold is detected, for example.

The WTRU may receive (e.g., via MAC CE) configuration information (e.g., a configuration) that indicates (e.g., includes) one or more (e.g., a set of) LTM candidate cells for reporting L1 measurements (e.g., CSI) and performing early synchronization. The configuration information may include one or more L1 measurement prediction criteria including, for example, one or more of: a prediction time (e.g., a time duration, a reporting period, or how far ahead to perform a prediction, where the time duration may be, for example, a single value, a range of values, one or more values for all measurements or per cell or beam, or a range from which the WTRU may select); cells to measure; a CSI reporting configuration; a CSI-RS resource configuration; an early synchronization trigger; an RA type for uplink synchronization (e.g., 2/4 step, a TA value for RACH-less, etc.); a reporting periodicity; and/or reporting triggers (e.g., a cell that has not been detected is predicted to become detectable, or has a radio condition above a threshold, or a measured cell has a radio condition above/below a threshold and should therefore be replaced).

The WTRU may (e.g., determine to) adjust the configured time duration (e.g., and to what value to adjust the time duration) based on one or more of the following: radio conditions (e.g., measured or predicted); a change in measured or predicted RSRP, per cell or beam, or based on serving cell measurement; a predicted event (e.g., N new cells may become detectable within the configured time); one or more beam measurements; and/or a target probability or accuracy of a prediction.

The WTRU may transmit an indication (e.g., to the network) of the adjusted time duration, and associated supplementary information (e.g., in a MAC CE).

The WTRU may indicate the adjusted time by sending an indication of the adjusted time duration to the network. The WTRU may receive a network indication of the time duration to be used (e.g., in a downlink MAC CE). The WTRU may indicate the adjusted time by adjusting the time duration and sending an indication of the adjusted time duration (e.g., that is being used) in a reported prediction measurement.

The indication may provide at least one of: the adjusted time duration, or another parameter (e.g., RSRP change rate) that may be used to determine the adjusted time duration at the network.

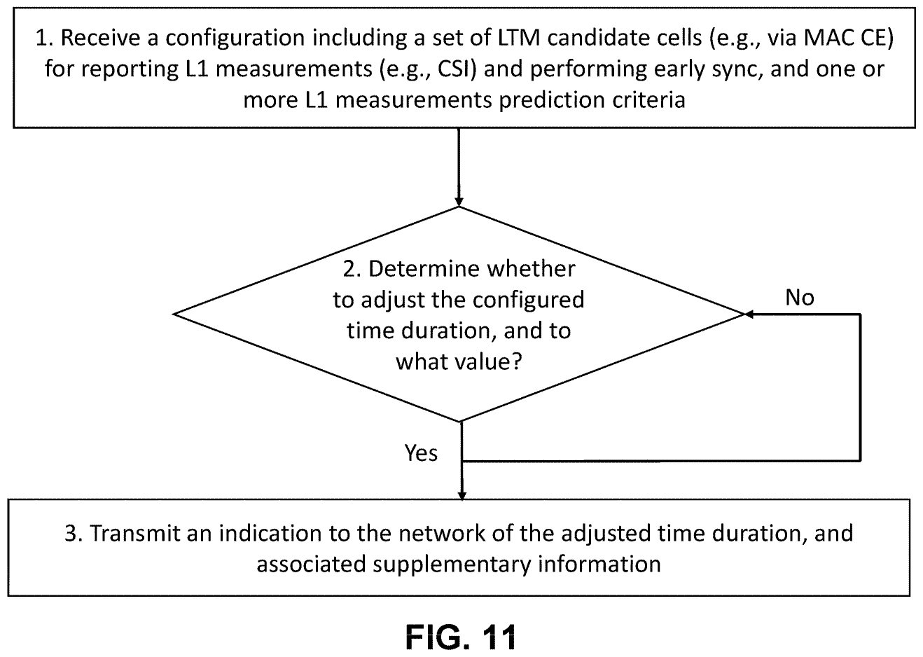

FIG. 11 illustrates an example of determining a prediction validity timescale.

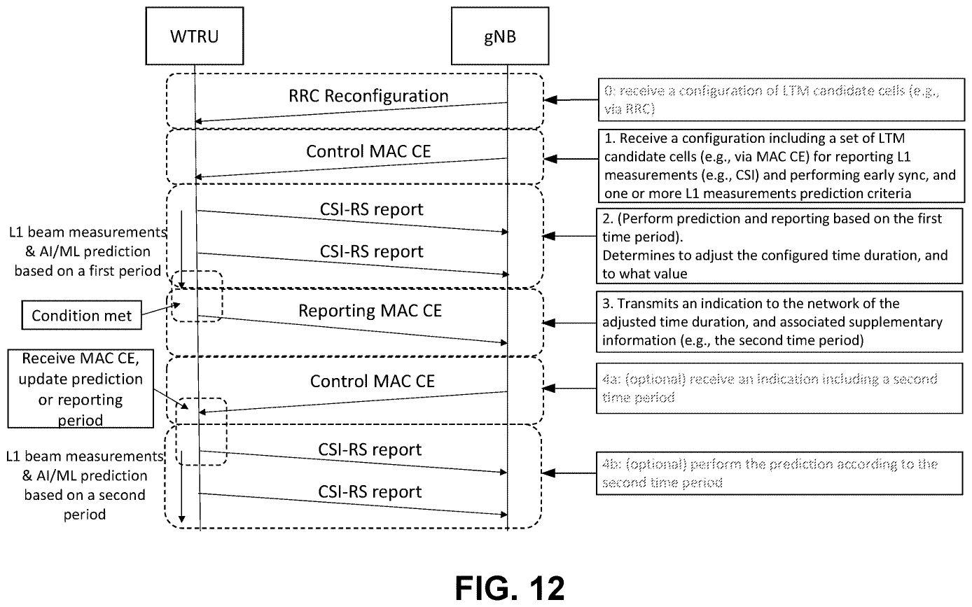

FIG. 12 illustrates example signaling associated with determining a prediction validity timescale (e.g., a network-triggered update).

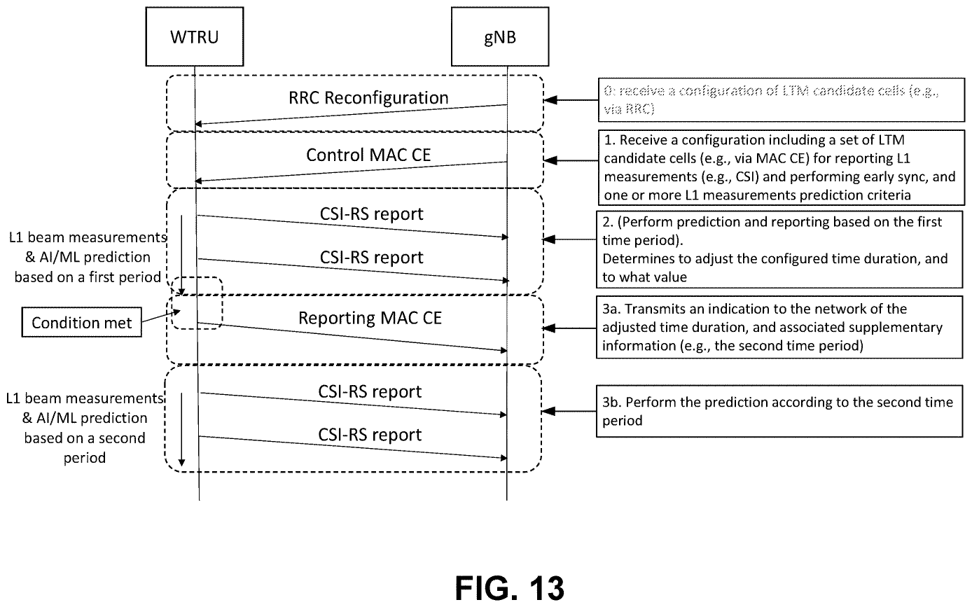

FIG. 13 illustrates example signaling associated with determining a prediction validity timescale (e.g., a WTRU autonomous update with an indication to the network).

As shown in FIGS. 12 and 13, at 0, the WTRU may receive a configuration of LTM candidate cells (e.g., via RRC). At 1, the WTRU may receive a configuration. The configuration may include a set of LTM candidate cells (e.g., via a MAC CE) for reporting L1 measurements (e.g., CSI) and performing early synchronization, and/or one or more L1 measurements prediction criteria. The configuration received at 1 may be a subset of the configuration received at 0. At 2, The WTRU may perform prediction and reporting based on the first time period. The WTRU may evaluate, based on certain conditions, whether to adjust the configured time duration, and to what value.

As shown in FIG. 12, at 3, the WTRU may transmit an indication (e.g., to the network) of the adjusted time duration, and associated supplementary information (e.g., the second time period). At 4a, the network may (e.g., after the WTRU transmits the indication) transmit (and the WTRU may receive) an indication including a second time period. At 4b, if the WTRU receives (e.g., only if the WTRU receives) an indication from the network (e.g., the indication received at 4a), the WTRU may perform the prediction according to the second time period.

As shown in FIG. 13, at 3a, the WTRU may transmit an indication (e.g., to the network) of the adjusted time duration, and associated supplementary information (e.g., the second time period). At 3b, the WTRU may (e.g., automatically, without receiving an indication from the network) perform the prediction according to the second time period.

Feature(s) associated with configuration of LTM candidate cells are provided herein.

The WTRU may receive a configuration of RRC candidate cells (e.g., via RRC reconfiguration, for example, as described at 0 in FIGS. 12 and 13). The WTRU may (e.g., subsequently) receive configuration information (e.g., via a MAC CE) that enables a set of the cell configurations received by RRC (this subset of the cell configurations received by RRC is referred to as “the set of candidate cells” at 1 in FIGS. 12 and 13). The configuration of a set of RRC candidate cells may include an indication to perform one or more actions associated with those cells (e.g., to perform L1 measurement evaluation, CSI reporting, and/or downlink or uplink synchronization procedures). The configuration of a set of candidate cells may include an indication (e.g., an identity or index) of one or more of the RRC candidate cell configurations and/or one or more measurement configurations to be used for evaluating the candidate cells.

Example configuration information for evaluating and reporting are provided herein.

The measurement configurations and/or L1 measurement evaluation criteria may refer to actual (e.g., performed) measurements, or predicted measurements, or both (e.g., a combination or mixture). The measurement configurations may include L1 measurement evaluation criteria (e.g., L1 measurement prediction criteria), for example one or more of the following: a prediction time/a time duration indicative of a future time (e.g., a reporting period, or how far ahead to perform a prediction, where the time duration may be, for example, a single value, or a range (such as a range from which the WTRU selected), for all measurements, or per cell or beam); cells to measure; a CSI reporting configuration; a CSI-RS resource configuration; an early synchronization trigger; an RA type for uplink synchronization (e.g., 2 or 4 step, TA value for RACH-less); a reporting periodicity; reporting triggers (e.g., a cell that has not been detected is predicted to become detectable, or has a radio condition above a threshold, or a measured cell has a radio condition above/below a threshold); reporting triggers (e.g., radio signal quality thresholds); PCIs; beam identifiers (e.g., indexes); SSB resource configuration; MAC CE reporting configurations; a reporting quantity (e.g., RSRP, etc.); a reporting threshold (e.g., an absolute RSRP threshold above which a beam measurement may be reported); an evaluation threshold (e.g., a rate of change of RSRP threshold, above which the WTRU may determine to update the time period); a predictive model/model ID; predictive model inputs (e.g., current measurements, past measurements, throughput); and/or a target probability or accuracy of a prediction.

The criteria for evaluating may be the same or different criteria than the criteria for reporting. For example, the criteria for reporting may be a predicted beam or cell RSRP measurement. The criteria for evaluation may be a (e.g., real, not predicted) beam or cell RSRP measurement. The reporting and evaluating criteria may be any one or more of the L1 measurement evaluation criteria described herein.

One or more values may be used, for example, a first cell or beam may use a first time duration (or other criteria) and a second cell or beam may use a second time duration (or other criteria).

Example conditions for sending an indication are provided herein.

The WTRU may predict a measurement value associated with a candidate cell, for example, using the predictive model and the indicated/configured prediction time. The WTRU may determine that a time adjustment condition has been satisfied. For example, the WTRU may determine (e.g., based on the L1 measurement evaluation criteria) that the time period used for the evaluation is to be updated. Based on the time adjustment condition being satisfied, the WTRU may determine a second prediction time indicative of a second future time.

The WTRU may determine that the time adjustment condition is satisfied if the WTRU determines that a rate of change of a measurement value is greater than a threshold. For example, if the WTRU is (e.g., currently) performing reporting of predicted beam measurements according to a first (e.g., longer) time duration, and if the evaluation criteria is met (e.g., the rate of change of RSRP is greater than a threshold), then the WTRU may determine to perform predicted beam measurements according to a second (e.g., shorter) time period. Similarly, the WTRU may determine that the time adjustment condition is satisfied if the WTRU determines that a rate of change of a measurement value is less than a threshold. For example, if the WTRU is (e.g., currently) performing reporting of predicted beam measurements according to a first (e.g., shorter) time duration, and if the evaluation criteria is met (e.g., the rate of change of RSRP is less than a threshold), then the WTRU may determine to perform predicted beam measurements according to a second (e.g., longer) time period.

The time duration may be scaled relative to the evaluation criteria. For example, if the rate of change of RSRP is N (e.g., N dB/milliseconds), the time period may be N*X milliseconds (e.g., where X is a multiplication factor).

The time duration may be selected from a list (e.g., a configured or predefined list) of values (e.g., based on one or more thresholds). For example, the WTRU may determine that a value of a measurement has changed by an amount. For example, if the beam measurements change by an amount above threshold X, time duration A may be used. As another example, if the beam measurements change by an amount above a threshold Y (e.g., which may be greater than X), time duration B may be used.

If the time duration changes, the WTRU may send an indication of the determined prediction time (e.g., to inform the network of the time duration change).

If the WTRU determines to send an indication, the WTRU may update the time duration used for predictive measurements. The WTRU may update the time duration used for predictive measurements automatically (e.g., according autonomously as described with respect to FIG. 13), or the WTRU may wait to receive an indication from the network (e.g., as described with respect to FIG. 12, where the indication may be a confirmation or an index or indication of an explicit time period, for example, received in a MAC CE or DCI). The WTRU may then predict, using the predictive model and the updated prediction time, a measurement value associated with the candidate cell. For example, the first measurement value (e.g., before updating the prediction time) may be an output of the predictive model generated by use of, as inputs to the predictive model, the first prediction time and at least one of: a past measurement value associated with the candidate cell or a current measurement value associated with the candidate cell. Similarly, the second measurement value (e.g., taken after updating the prediction time) may be an output of the predictive model generated by use of, as inputs to the predictive model, the second prediction time and at least one of: a past measurement value associated with the candidate cell or a current measurement value associated with the candidate cell.

Feature(s) associated with contents of the indication are provided herein.

The indication may be sent in a MAC CE, an RRC message, or a CSI-RS report, or other UCI.

The indication may include an indication (e.g., a 1-bit flag) that the time duration is to be increased or decreased by a (e.g., one) unit (e.g., the next or previous value in a range). The indication may include an (e.g., explicit) indication of the selected time duration.

The indication may include a value to indicate which criteria has been met, for example, an index to a list of configured evaluation criteria.

The indication may include a measured value. For example, the indication may include a rate of change of RSRP (e.g., with respect to FIG. 12, the rate of change of RSRP may be used by the network to determine a new time duration).

The indication may include a reference to the beams or cells meeting the criteria. One or more values may be transmitted (e.g., if the evaluation or measurements reported are done per cell or per beam or per resource).

The indication may include a timescale (e.g., how far in advance the prediction was made) or a probability or accuracy of the prediction (e.g., 90% probability that the prediction is correct).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1. A wireless transmit/receive unit (WTRU) comprising:
a processor configured to:
receive configuration information, wherein the configuration information indicates a set of layer one/layer two (L1/L2) triggered mobility (LTM) candidate cells, a predictive model, and a measurement threshold;
predict, using the predictive model, a measurement value associated with an LTM candidate cell, wherein the LTM candidate cell is in the set of LTM candidate cells;
select the LTM candidate cell based, at least in part, on the predicted measurement value satisfying the measurement threshold;
send, to a network entity, a message that indicates the selected LTM candidate cell; and
perform channel state information (CSI) reporting on the selected LTM candidate cell.

2. The WTRU of claim 1, wherein the predicted measurement value is an output of the predictive model generated by use, as an input to the predictive model, of at least one of: a past measurement value associated with the LTM candidate cell or a current measurement value associated with the LTM candidate cell.

3. The WTRU of claim 1, wherein the predicted measurement value is associated with a reliability indicative of a probability that the predicted measurement value is accurate, and wherein the message further indicates the predicted measurement value and the reliability.

4. The WTRU of claim 1, wherein the predicted measurement value associated with the LTM candidate cell is a first predicted measurement value, the LTM candidate cell is a first LTM candidate cell, and wherein the processor is further configured to:
predict, using the predictive model, a second measurement value associated with a second LTM candidate cell, wherein the second LTM candidate cell is in the set of LTM candidate cells, wherein the second predicted measurement value is an output of the predictive model generated by use, as an input to the predictive model, of at least one of: a past measurement value associated with the second LTM candidate cell or a current measurement value associated with the second LTM candidate cell; and
select the second LTM candidate cell from the set of LTM candidate cells based, at least in part, on the second predicted measurement value satisfying the measurement threshold, wherein the message further indicates the second LTM candidate cell.

5. The WTRU of claim 1, wherein the predicted measurement value associated with the LTM candidate cell is a first predicted measurement value, the LTM candidate cell is a first LTM candidate cell, and wherein the processor is further configured to:
predict, using the predictive model, a second measurement value associated with a second LTM candidate cell, wherein the second LTM candidate cell is in the set of LTM candidate cells, wherein the second predicted measurement value is an output of the predictive model generated by use, as an input to the predictive model, of at least one of: a past measurement value associated with the second LTM candidate cell or a current measurement value associated with the second LTM candidate cell, and wherein the second predicted measurement value satisfies the measurement threshold; and
wherein the processor being configured to select the first LTM candidate cell based, at least in part, on the first predicted measurement value satisfying the measurement threshold comprises the processor being configured to:
determine a first difference between the first predicted measurement value and the measurement threshold, and a second difference between the second predicted measurement value and the measurement threshold; and
on a condition that the first difference is greater than the second difference, select the first LTM candidate cell.

6. The WTRU of claim 1, wherein the processor being configured to predict the measurement value associated with the LTM candidate cell comprises the processor being configured to perform the prediction at a first time, the configuration information further indicates a timescale indicative of a second time after the first time at which the measurement value is predicted, and the processor being configured to predict the measurement value associated with the LTM candidate cell comprises the processor being configured to predict, at the first time, a value of the measurement at the second time, wherein the message further indicates the timescale.

7. The WTRU of claim 1, wherein the processor is further configured to:
determine that a candidate cell selection condition has been satisfied; and
determine, based on the candidate cell selection condition being satisfied, to evaluate one or more LTM candidate cells in the set of LTM candidate cells for selection.

8. A method comprising:
receiving configuration information, wherein the configuration information indicates a set of layer one/layer two (L1/L2) triggered mobility (LTM) candidate cells, a predictive model, and a measurement threshold;
predicting, using the predictive model, a measurement value associated with an LTM candidate cell, wherein the LTM candidate cell is in the set of LTM candidate cells;
selecting the LTM candidate cell based, at least in part, on the predicted measurement value satisfying the measurement threshold;
sending, to a network entity, a message that indicates the selected LTM candidate cell; and
performing channel state information (CSI) reporting on the selected LTM candidate cell.

9. The method of claim 8, wherein the predicted measurement value is an output of the predictive model generated by use, as an input to the predictive model, of at least one of: a past measurement value associated with the LTM candidate cell or a current measurement value associated with the LTM candidate cell.

10. The method of claim 8, wherein the predicted measurement value is associated with a reliability indicative of a probability that the predicted measurement value is accurate, and wherein the message further indicates the predicted measurement value and the reliability.

11. The method of claim 8, wherein the predicted measurement value associated with the LTM candidate cell is a first predicted measurement value, the LTM candidate cell is a first LTM candidate cell, and wherein the method further comprises:
predicting, using the predictive model, a second measurement value associated with a second LTM candidate cell, wherein the second LTM candidate cell is in the set of LTM candidate cells, wherein the second predicted measurement value is an output of the predictive model generated by use, as an input to the predictive model, of at least one of: a past measurement value associated with the second LTM candidate cell or a current measurement value associated with the second LTM candidate cell; and
selecting the second LTM candidate cell from the set of LTM candidate cells based, at least in part, on the second predicted measurement value satisfying the measurement threshold, wherein the message further indicates the second LTM candidate cell.

12. The method of claim 8, wherein the predicted measurement value associated with the LTM candidate cell is a first predicted measurement value, the LTM candidate cell is a first LTM candidate cell, and wherein the method further comprises:
predicting, using the predictive model, a second measurement value associated with a second LTM candidate cell, wherein the second LTM candidate cell is in the set of LTM candidate cells, wherein the second predicted measurement value is an output of the predictive model generated by use, as an input to the predictive model, of at least one of: a past measurement value associated with the second LTM candidate cell or a current measurement value associated with the second LTM candidate cell, and wherein the second predicted measurement value satisfies the measurement threshold; and
wherein selecting the first LTM candidate cell based, at least in part, on the first predicted measurement value satisfying the measurement threshold comprises:
determining a first difference between the first predicted measurement value and the measurement threshold, and a second difference between the second predicted measurement value and the measurement threshold; and
on a condition that the first difference is greater than the second difference, selecting the first LTM candidate cell.

13. The method of claim 8, wherein predicting the measurement value associated with the LTM candidate cell comprises performing the prediction at a first time, the configuration information further indicates a timescale indicative of a second time after the first time at which the measurement value is predicted, and predicting the measurement value associated with the LTM candidate cell comprises predicting, at the first time, a value of the measurement at the second time, wherein the message further indicates the timescale.

14. The method of claim 8, wherein the method further comprises:
determining that a candidate cell selection condition has been satisfied; and
determining, based on the candidate cell selection condition being satisfied, to evaluate one or more LTM candidate cells in the set of LTM candidate cells for selection.
